(19) United States
(12) Patent Application Publication
(10) Pub. No.: US 2016/0273475 A1
(43) Pub. Date: Sep. 22, 2016

(54) CONTROL SYSTEM FOR SPARK-IGNITION INTERNAL COMBUSTION ENGINE

(71) Applicant: TOYOTA JIDOSHA KABUSHIKI KAISHA, Toyota-shi, Aichi-ken (JP)

(72) Inventor: Chikara DODATE, Susono-shi, Shizuoka-ken (JP)

(73) Assignee: TOYOTA JIDOSHA KABUSHIKI KAISHA, Toyota-shi, Aichi-ken (JP)

(21) Appl. No.: 15/034,629

(22) PCT Filed: Oct. 30, 2014
(86) PCT No.: PCT/IB2014/002272

§ 371 Date: May 5, 2016

(30) Foreign Application Priority Data
Nov. 7, 2013 (JP) 2013-231124

(51) Int. Cl. F02D 41/30; F02D 41/40; F02P 13/00; F02D 35/00; F02M 57/04

(52) U.S. Cl. CPC F02D 41/3094; F02D 35/0007; F02M 57/04; F02P 13/00; F02D 41/401

(57) ABSTRACT

In an internal combustion engine, an ignition plug is arranged near a center of an upper wall surface of a combustion chamber, and is used to ignite air-fuel mixture. Fuel injected from a port fuel injection valve is directed toward the center of the combustion chamber when the intake valve is open. The engine is configured to generate a tumble flow in a cylinder. A flow speed of gas around the ignition plug during ignition is controlled by changing a pattern of tumble flow between an ordinary first tumble flow pattern and a different second tumble flow pattern on the basis of an engine rotation speed. The tumble flow having the second pattern is generated by overlapping a fuel injection period of the port fuel injection valve with the open period of the intake valve.

### BACKGROUND OF THE INVENTION

1. Field of the Invention

The invention relates to a control system for a spark-ignition internal combustion engine.

2. Description of Related Art

For example, Japanese Patent Application Publication No. 2012-021501 (JP 2012-021501 A) describes a control system for an internal combustion engine including a tumble control valve that generates a tumble flow in a cylinder. In this control system, an estimated tumble ratio is calculated on the basis of a detected value of a first air flow meter provided upstream of a throttle valve and a detected value of a second air flow meter provided just downstream of the tumble control valve. The opening degree of the tumble control valve is subjected to feedback control so that the estimated tumble ratio follows a target tumble ratio. The target tumble ratio is set to a value within an allowable control range for avoiding misfire or instable combustion.

### SUMMARY OF THE INVENTION

Even when the tumble ratio (Tumble flow speed/Engine rotation speed) is controlled so as to fall within a set range, the tumble flow speed changes with a change in the engine rotation speed. It becomes difficult to attain stable ignition if a gas flow speed around an ignition plug during ignition is too high or too low. This is remarkable particularly in a lean-burn operation that is carried out under the condition that the concentration of fuel in air-fuel mixture is low, like an operation at an air-fuel ratio higher than a stoichiometric air-fuel ratio or an EGR operation in which air containing a large amount of EGR gas is burned.

The invention provides a control system for a spark-ignition internal combustion engine, which contributes to improvement in ignitability of air-fuel mixture.

A first aspect of the invention provides a control system for a spark-ignition internal combustion engine. The spark-ignition internal combustion engine includes an intake valve, an exhaust valve, an intake port, an ignition plug and a port fuel injection valve. The ignition plug is arranged near a center of an upper wall surface of a combustion chamber, and is configured to ignite air-fuel mixture. The port fuel injection valve is arranged in the intake port. A direction in which the port fuel injection valve injects fuel is set such that, when fuel is injected during an open period of the intake valve, the injected fuel is directed toward the center of the combustion chamber through an opening of the intake valve. The control system includes an electronic control unit. The electronic control unit is configured to: i) control a flow speed of gas around the ignition plug during ignition by changing a tumble flow between a first tumble flow and a second tumble flow, the first tumble flow being configured such that a flow direction of gas around the ignition plug during ignition is a direction directed from the intake valve toward the exhaust valve in a second half of a compression stroke, the second tumble flow being configured such that the flow direction of gas reverses from the direction directed from the intake valve toward the exhaust valve to a direction directed from the exhaust valve toward the intake valve in the second half of the compression stroke as a result of a change into a tumble flow having two swirl flow components in process of compression of the gas in the compression stroke, the two swirl flow components having mutually opposite rotational directions when the combustion chamber is viewed from an upper side; and ii) generate the second tumble flow by overlapping at least part of a fuel injection period of the port fuel injection valve with the open period of the intake valve.

By overlapping at least part of the fuel injection period of the port fuel injection valve having the configuration according to the first aspect with the open period of the intake valve, it is possible to increase the flow speed of gas flowing into the cylinder and flowing through the center of the combustion chamber with the use of fuel spray injected from the port fuel injection valve. As a result, it is possible to generate the second tumble flow. When the second tumble flow is generated, the flow speed of gas around the ignition plug starts decreasing in the compression stroke at the timing earlier than that when the first tumble flow is generated, and, finally, the direction of gas flow reverses. Thus, by changing the tumble flow between the first tumble flow of which a gas flow direction does not reverse around the ignition plug in the second half of the compression stroke and the second tumble flow of which the gas flow direction reverses, it is possible to control the flow speed of gas around the ignition plug during ignition. Thus, it is possible to provide the control system for a spark-ignition internal combustion engine, which contributes to improvement in ignitability of air-fuel mixture.

In the first aspect, the spark-ignition internal combustion engine may include an in-cylinder fuel injection valve configured to directly inject fuel into a cylinder of the spark-ignition internal combustion engine, and the electronic control unit may be configured to set the ratio of an amount of fuel injected by the port fuel injection valve to a total amount of fuel injected by the port fuel injection valve and the in-cylinder fuel injection valve such that the ratio in the case where the second tumble flow is generated is higher than the ratio in the case where the first tumble flow is generated.

With the above configuration, the second tumble flow is further reliably generated by increasing the ratio of the amount of fuel injected by the port fuel injection valve to the total amount in the case where the second tumble flow is generated.

In the first aspect, the electronic control unit may be configured to generate the second tumble flow when an engine rotation speed is higher than or equal to a predetermined speed.

With the above configuration, it is possible to suitably suppress an excessively high flow speed of gas around the ignition plug during ignition at a high engine rotation speed at which there is a concern of blow-off of discharge spark, and to prevent blow-off, of discharge spark.

In the first aspect, the electronic control unit may be configured to generate the second tumble flow when the flow speed of gas around the ignition plug during ignition is higher than or equal to a predetermined value, and the flow speed of gas around the ignition plug during ignition may be estimated on the assumption that the first tumble flow is generated.

With the above configuration, it is possible to suitably suppress an excessively high flow speed of gas around the ignition plug during ignition at a high engine rotation speed at which there is a concern of blow-off of discharge spark, and to prevent blow-off of discharge spark.

In the first aspect, the electronic control unit may be configured to, when the second tumble flow is generated, overlap part of the fuel injection period of the port fuel injection valve with the open period of the intake valve.

With the above configuration, the second tumble flow is generated, while the ability of mixing injected fuel with intake air is ensured.

A second aspect of the invention provides a control system for a spark-ignition internal combustion engine. The spark-ignition internal combustion engine is configured to generate a tumble flow in a cylinder of the spark-ignition internal combustion engine. The spark-ignition internal combustion engine includes an intake valve, an intake port, an ignition plug and a port fuel injection valve. The ignition plug is arranged near a center of an upper wall surface of a combustion chamber, and is configured to ignite air-fuel mixture. The port fuel injection valve is arranged in the intake port. A direction in which the port fuel injection valve injects fuel is set such that, when fuel is injected during an open period of the intake valve, the injected fuel is directed toward the center of the combustion chamber through an opening of the intake valve. The control system includes an electronic control unit. The electronic control unit is configured to change an injection mode of fuel by the port fuel injection valve between a first injection mode and a second injection mode, the first injection mode being configured such that fuel is injected during a closed period of the intake valve when an engine rotation speed is lower than a predetermined speed, the second injection mode being configured such that fuel is injected during a period, including at least part of the open period of the intake valve, when the engine rotation speed is higher than or equal to the predetermined speed.

In the second aspect, the spark-ignition internal combustion engine may include an in-cylinder fuel injection valve configured to directly inject fuel into the cylinder of the spark-ignition internal combustion engine, and the electronic control unit may be configured to set the ratio of an amount of fuel injected by the port fuel injection valve to a total amount of fuel injected by the port fuel injection valve and the in-cylinder fuel injection valve such that the ratio in the case where the second injection mode is selected is higher than the ratio in the case where the first injection mode is selected.

With the above configuration, the second tumble flow is further reliably generated by increasing the ratio of the amount of fuel injected by the port fuel injection valve to the total amount in the case where the second tumble flow is generated.

A third aspect of the invention provides a control system for a spark-ignition internal combustion engine. The spark-ignition internal combustion engine is configured to generate a tumble flow in a cylinder of the spark-ignition internal combustion engine. The spark-ignition internal combustion engine includes an intake valve, an intake port, an ignition plug, a port fuel injection valve and an in-cylinder fuel injection valve. The ignition plug is arranged near a center of an upper wall surface of a combustion chamber, and is configured to ignite air-fuel mixture. The port fuel injection valve is arranged in the intake port. A direction in which the port fuel injection valve injects fuel is set such that, when fuel is injected during an open period of the intake valve, the injected fuel is directed toward the center of the combustion chamber through an opening of the intake valve. The in-cylinder fuel injection valve is configured to directly inject fuel into the cylinder of the spark-ignition internal combustion engine. The control system includes an electronic control unit. The electronic control unit is configured to change an injection mode of fuel between a first injection mode and a second injection mode, the first injection mode being configured such that, when an engine rotation speed is lower than a predetermined speed, fuel is injected by using the in-cylinder fuel injection valve without using the port fuel injection valve, the second injection mode being configured such that, when the engine rotation speed is higher than or equal to the predetermined speed, fuel is injected by using at least the port fuel injection valve out of the port fuel injection valve and the in-cylinder fuel injection valve while at least part of a fuel injection period of the port fuel injection valve is overlapped with the open period of the intake valve.

In the second or third aspect, the electronic control unit may be configured to, when the second injection mode is selected, overlap part of the fuel injection period of the port fuel injection valve with the open period of the intake valve.

With the above configuration, the second tumble flow is generated, while the ability of mixing injected fuel with intake air is ensured.

By overlapping at least part of the fuel injection period of the port fuel injection valve having the configuration according to the second or third aspect with the open period of the intake valve, it is possible to increase the flow speed of gas flowing into the cylinder and flowing through the center of the combustion chamber with the use of fuel spray injected from the port fuel injection valve. As a result, in process in which in-cylinder gas is compressed in the compression stroke, the tumble flow changes into the tumble flow having opposite two swirl flow components having mutually opposite rotational directions in the compression stroke when the combustion chamber is viewed from the above. Thus, it is possible to generate the second tumble flow such that the flow direction of gas around the ignition plug during ignition reverses from the direction directed from the intake valve side toward the exhaust valve side in the second half of the compression stroke to the direction from the exhaust valve side to the intake valve side. When such a tumble flow is generated, the flow speed of gas around the ignition plug starts decreasing in the compression stroke at the timing earlier than that when the ordinary first tumble flow is generated, and, finally, the direction of gas flow reverses. Thus, by changing the tumble flow on the basis of the engine rotation speed between the first tumble flow of which the gas flow direction does not reverse around the ignition plug in the second half of the compression stroke and the second tumble flow of which the gas flow direction reverses, it is possible to control the flow speed of gas around the ignition plug during ignition. Thus, it is possible to provide the control system for a spark-ignition internal combustion engine, which contributes to improvement in ignitability of air-fuel mixture.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view for illustrating the system configuration of an internal combustion engine according to a first embodiment of the invention;

FIG. 2 is a view for illustrating the specific configuration of each port fuel injection valve shown in FIG. 1;

FIG. 3 is a graph that shows the relationship among a delay of ignition of air-fuel mixture, a gas flow speed around an ignition plug and a concentration of fuel in air-fuel mixture;

FIG. 4A, FIG. 4B, FIG. 4C, FIG. 4D, and FIG. 4E are views that show the behavior of discharge spark during a discharge period in time sequence in the case of occurrence of discharge interruption.

FIG. 5A, FIG. 5B, and FIG. 5C are views for illustrating the characteristic of an ordinary tumble flow pattern.

FIG. 6A, FIG. 6B, and FIG. 6C are views for illustrating the characteristic of an ω tumble flow pattern.

FIG. 7 is a view that shows a change in the gas flow speed in a cylinder in the second half of a compression stroke at the time when a tumble flow having an ω tumble flow pattern is generated;

FIG. 8A and FIG. 8B are views for illustrating a condition suitable for generating a tumble flow having an ω tumble flow pattern;

FIG. 9 is a graph for illustrating a change in the near-plug flow speed in the second half of a compression stroke by comparison between the ordinary tumble flow pattern and the ω tumble flow pattern;

FIG. 10 is a graph for illustrating characteristic control over a near-plug flow speed during ignition according to the first embodiment of the invention;

FIG. 11A and FIG. 11B are views for illustrating flow of gas flowing into each cylinder when fuel is injected in an intake asynchronous injection mode;

FIG. 12A and FIG. 12B are views for illustrating flow of gas flowing into each cylinder when fuel is injected in an intake synchronous injection mode;

FIG. 13A and FIG. 13B are graphs for illustrating a method of controlling the near-plug flow speed during ignition according to the first embodiment of the invention;

FIG. 14 is a flowchart of a routine that is executed according to the first embodiment of the invention;

FIG. 15 is a flowchart of a routine that is executed according to an alternative embodiment to the first embodiment of the invention;

FIG. 16 is a schematic view for illustrating the system configuration of an internal combustion engine according to a second embodiment of the invention;

FIG. 17 is a flowchart of a routine that is executed according to the second embodiment of the invention;

FIG. 18 is a flowchart of a routine that is executed according to an alternative embodiment to the second embodiment of the invention; and

FIG. 19 is a graph for illustrating a specific example of a method of utilizing the intake synchronous injection mode in which fuel is injected by using the port fuel injection valves for generating a tumble flow having an ω tumble flow pattern.

### DETAILED DESCRIPTION OF EMBODIMENTS

### First Embodiment

### Description of System Configuration of First Embodiment

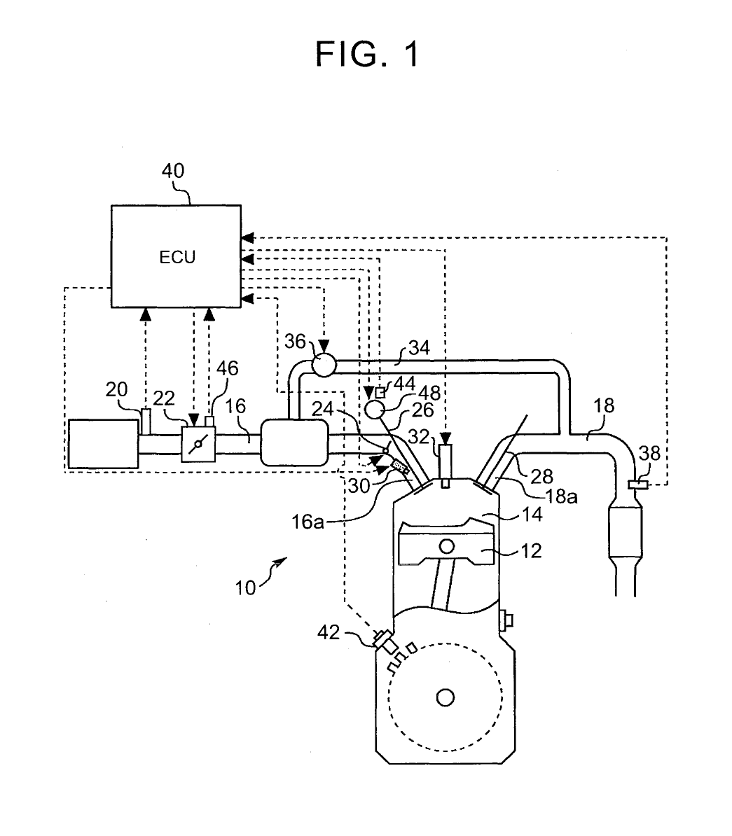

FIG. 1 is a schematic view for illustrating the system configuration of an internal combustion engine 10 according to a first embodiment of the invention. The system according to the present embodiment includes the spark-ignition internal combustion engine 10. A piston 12 is provided in each cylinder of the internal combustion engine 10. A combustion chamber 14 is formed on the top side of the piston 12 in each cylinder. An intake passage 16 and an exhaust passage 18 communicate with each combustion chamber 14.

An air flow meter 20 is provided near an inlet of the intake passage 16. The air flow meter 20 outputs a signal corresponding to the flow rate of air that is taken into the intake passage 16. An electronically controlled throttle valve 22 is provided downstream of the air flow meter 20. An electronically controlled tumble control valve (TCV) 24 is provided in each of portions of the intake passage 16, which are branched off toward the corresponding cylinders. Each TCV 24 generates a tumble flow (longitudinal vortex flow) in the corresponding cylinder by biasing the flow of intake air in a corresponding one of pairs of intake ports 16a.

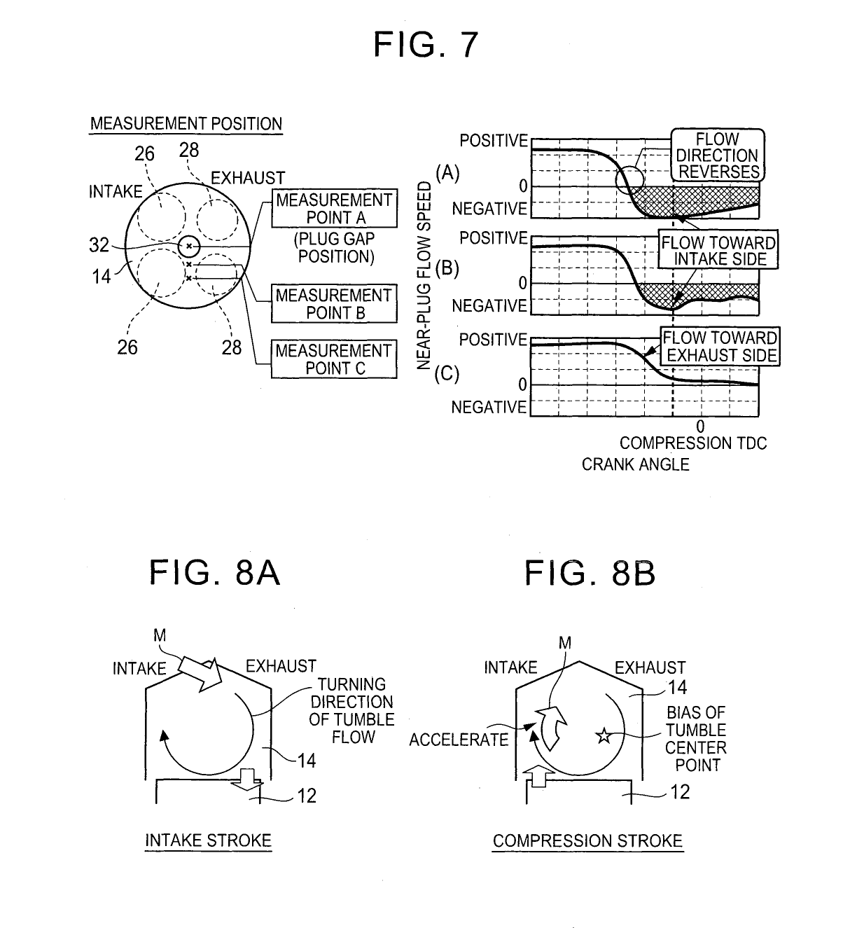

An intake valve 26 is provided at each intake port 16a of the intake passage 16. Each intake valve 26 opens or closes the corresponding intake port 16a. An exhaust valve 28 is provided at each exhaust port 18a of the exhaust passage 18. Each exhaust valve 28 opens or closes the corresponding exhaust port 18a. A port fuel injection valve 30 is provided in correspondence with each cylinder of the internal combustion engine 10. Each port fuel injection valve 30 is used to inject fuel into the corresponding intake ports 16a. An ignition plug 32 of an ignition device (not shown) is further provided in each cylinder. Each ignition plug 32 of the ignition device is used to ignite air-fuel mixture. More specifically, each ignition plug 32 is arranged near the center of an upper wall surface (that is, a cylinder head-side wall surface) of the corresponding combustion chamber 14. As shown in FIG. 7, and the like (described later), the two intake valves 26 are provided side by side in each cylinder, and the two exhaust valves 28 are provided side by side across (the corresponding ignition plug 32) from the intake valves 26.

The internal combustion engine 10 includes an EGR passage 34 that connects the intake passage 16 to the exhaust passage 18. An EGR valve 36 is arranged in the middle of the EGR passage 34. The EGR valve 36 is used to adjust the amount of EGR gas (external EGR gas) that is circulated to the intake passage 16 via the EGR passage 34. The flow rate of exhaust gas (EGR gas) flowing through the EGR passage 34 is changed by changing the opening degree of the EGR valve 36. Thus, it is possible to adjust the EGR rate. An air-fuel ratio sensor 38 is arranged in the exhaust passage 18. The air-fuel ratio sensor 38 is used to detect the air-fuel ratio of exhaust gas.

The system shown in FIG. 1 includes an electronic control unit (ECU) 40. Not only the above-described air flow meter 20 and air-fuel ratio sensor 38 but also various sensors for detecting the operating states of the internal combustion engine 10 are connected to an input port of the ECU 40. The various sensors include a crank angle sensor 42, an intake cam angle sensor 44, a throttle opening degree sensor 46, and the like. The crank angle sensor 42 is used to detect an engine rotation speed. The intake cam angle sensor 44 is used to detect a rotation angle of an intake camshaft (not shown) that drives the intake valves 26. The throttle opening degree sensor 46 is used to detect a throttle opening degree. Not only the above-described throttle valve 22, TCVs 24, port fuel injection valves 30, ignition plugs 32, and EGR valve 36 but also various actuators for controlling the operation of the internal combustion engine 10 are connected to an output port of the ECU 40. The various actuators include an intake valve timing mechanism 48 that controls the open/close timing of each intake valve 26. The ECU 40 executes not only predetermined engine control, such as fuel injection control and ignition control, but also control over a tumble flow (described later) by operating the various actuators in accordance with the above-described various sensors and a predetermined program.

### Specific Configuration of Each Port Fuel Injection Valve

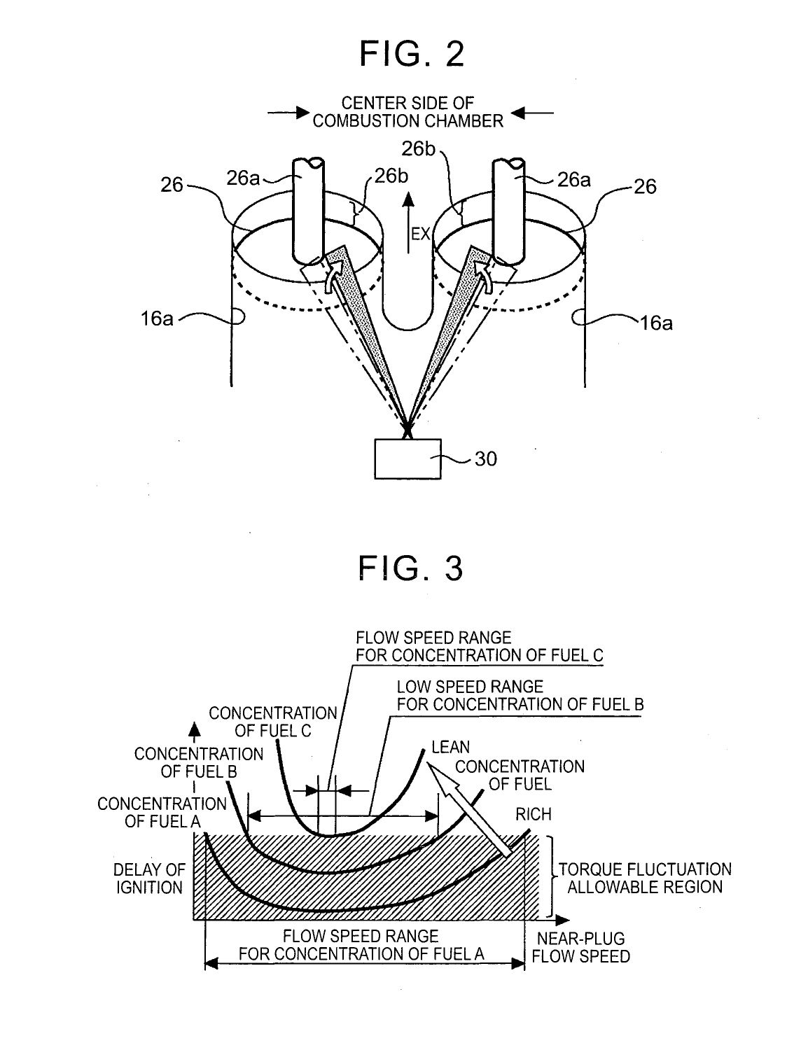

FIG. 2 is a view for illustrating the specific configuration of each port fuel injection valve 30 shown in FIG. 1. A port fuel injection valve having an ordinary configuration is configured to inject fuel toward a stem portion 26a of each intake valve 26 (that is, toward the center position of each intake port 16a) as indicated by the alternate long and two-short dashed lines in FIG. 2.

In contrast, each port fuel injection valve 30 according to the present embodiment is configured to inject fuel toward the inner side of the two stem portions 26a arranged next to each other (that is, toward the center side of the combustion chamber 14 with respect to the stem portions 26a) as indicated by the continuous lines in FIG. 2. By employing such a configuration, each port fuel injection valve 30 is configured as follows. The direction in which fuel is injected is set such that, when fuel is injected during the open period of the corresponding intake valves 26, the injected fuel is directed toward the center side of the combustion chamber 14 (cylinder bore center side) through each opening 26b (each clearance formed between the opening end of each intake port 16a and the plug of the corresponding intake valve 26).

### Necessity of Control Over Gas Flow Speed Around Each Ignition Plug During Ignition in Lean-Burn Operation

FIG. 3 is a graph that shows the relationship among a delay of ignition of air-fuel mixture, a gas flow speed around the ignition plug 32 and a concentration of fuel in air-fuel mixture. An operation region of the internal combustion engine 10 includes a lean-burn operation region in which the concentration of fuel in air-fuel mixture is low (the ratio of fuel to air (including EGR gas when EGR gas is introduced) is small). In this way, when a high or low concentration of fuel in air-fuel mixture is described in this specification, not only air but also EGR gas is assumed to be included. More specifically, the lean-burn operation is carried out under the condition that the concentration of fuel in air-fuel mixture is lower than that of a reference condition because the amount of air or the amount of EGR gas in the lean-burn operation is larger than that of the reference condition. The reference condition is that the internal combustion engine 10 is operated at an EGR rate of zero and a stoichiometric air-fuel ratio. In other words, the lean-burn operation is carried out under the condition that the concentration of fuel in air-fuel mixture is lower than or equal to a predetermined value (the condition that there is a concern about deterioration of ignitability (delay of ignition) of air-fuel mixture). The lean-burn operation region is identified by an engine rotation speed and an engine load.

Thus, the lean-burn operation in this specification includes not only an operation that is carried out at an air-fuel ratio higher than the stoichiometric air-fuel ratio (that is, an operation that is carried out at a concentration of fuel reduced by increasing the ratio of the amount of air to the amount of fuel) but also an operation that is carried out at a high EGR rate resulting from introduction of a large amount of EGR gas (that is, an operation that is carried out at a concentration of fuel reduced by increasing the ratio of the amount of EGR gas to the amount of fuel). Such an operation at a high EGR rate may include an operation that is carried out at an air-fuel ratio near the stoichiometric air-fuel ratio.

In the lean-burn operation that achieves high thermal efficiency, it is important to reduce NOx emitted from the internal combustion engine 10 by reducing the concentration of fuel in air-fuel mixture in each cylinder. However, during lean-burn operation (particularly, during homogeneous lean-burn combustion that is carried out by homogeneously forming lean air-fuel mixture in the cylinder like the internal combustion engine 10 according to the present embodiment), an excessively lean concentration of fuel becomes a factor that leads to instable combustion.

As shown in FIG. 3, during lean-burn operation, a delay of ignition of air-fuel mixture extends as the concentration of fuel reduces. As a delay of ignition extends, torque fluctuations of the internal combustion engine 10 increase. A delay of ignition changes with a gas flow speed around the ignition plug 32 (hereinafter, referred to as “near-plug flow speed”) during ignition (during a discharge period of the ignition plug 32). Thus, in order to obtain stable combustion by causing a delay of ignition to fall within the range in which torque fluctuations become an allowable level, it is required to cause the near-plug flow speed during ignition to fall within a set range. For this, a predetermined flow speed range of the near-plug flow speed narrows as the concentration of fuel becomes leaner as shown in FIG. 3.

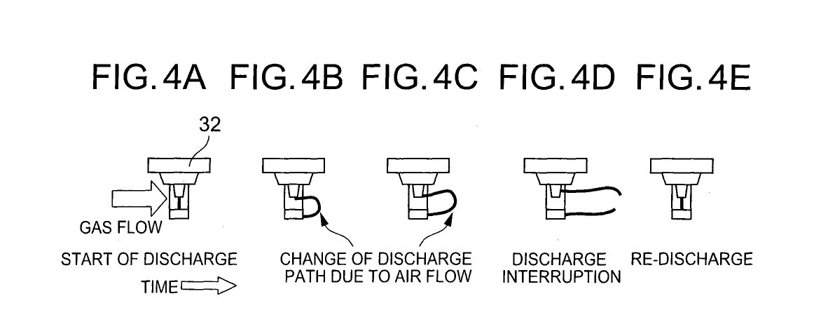

Between a delay of ignition and a near-plug flow speed, there is a relationship that a delay of ignition extends as the near-plug flow speed changes toward a high flow speed side or a low flow speed side with respect to a certain flow speed value (optimal value). Next, the reason why a delay of ignition extends at a high flow speed side or a low flow speed side will be described with reference to FIG. 4A to FIG. 4E. FIG. 4A to FIG. 4E are views that show the behavior of discharge spark during a discharge period in time sequence in the case of occurrence of discharge interruption.

After discharge is started as shown in FIG. 4A, electric spark generated at a plug gap is carried as shown in FIG. 4B and FIG. 4C by a gas flow around the ignition plug 32. Thus, a discharge path length extends. When discharge occurs, gas in the path of discharge spark is ionized, so electric resistance decreases. However, if the discharge path becomes too long because of a high near-plug flow speed, an electric resistance value in the discharge path becomes larger than an electric resistance value at a minimum distance of the plug gap, so discharge interruption occurs as shown in FIG. 4D. When discharge interruption has occurred, re-discharge is immediately carried out at the minimum distance of the plug gap as shown in FIG. 4E.

Initially, the reason why ignitability deteriorates at a high flow speed side will be described. At a concentration of fuel near a lean limit, a certain time is required until air-fuel mixture ignites (chemical reaction starts). As the near-plug flow speed increases, a time to discharge interruption shortens, so a time is insufficient until the same air-fuel mixture at a certain position is heated by electric spark to ignite. As a result, ignitability deteriorates.

Next, the reason why ignitability deteriorates at a low flow speed side will be described. An energy of electric spark per unit length through discharge depends on the characteristics of an ignition coil, and is constant irrespective of the discharge path length. Therefore, as the discharge path extends by air flow, or the like, an energy supplied to the whole air-fuel mixture increases, and the volume of air-fuel mixture to be heated also increases. However, as the near-plug flow speed decreases, the discharge path is difficult to extend, so an increase in the supplied energy or an increase in the volume of air-fuel mixture does not occur. As a result, ignitability deteriorates.

As described above, in order to obtain stable combustion by causing a delay of ignition to fall within the range in which torque fluctuations become an allowable level, it is required to cause the near-plug flow speed during ignition to fall within a set range. The flow speed of gas flowing into each cylinder is directly proportional to the engine rotation speed. Thus, when no control is executed over the near-plug flow speed, the near-plug flow speed monotonously increases in proportion to the engine rotation speed as indicated by the dashed line in FIG. 10 (described later). Therefore, in the present embodiment, the near-plug flow speed during ignition in the lean-burn operation region is controlled by changing the pattern of a tumble flow that is generated in each cylinder. More specifically, the pattern of the tumble flow is changed between an ordinary tumble flow pattern (first tumble flow pattern) and an ω tumble flow pattern (second tumble flow pattern) defined below.

### Mechanism of Generating Tumble Flow Having Co Tumble Flow Pattern

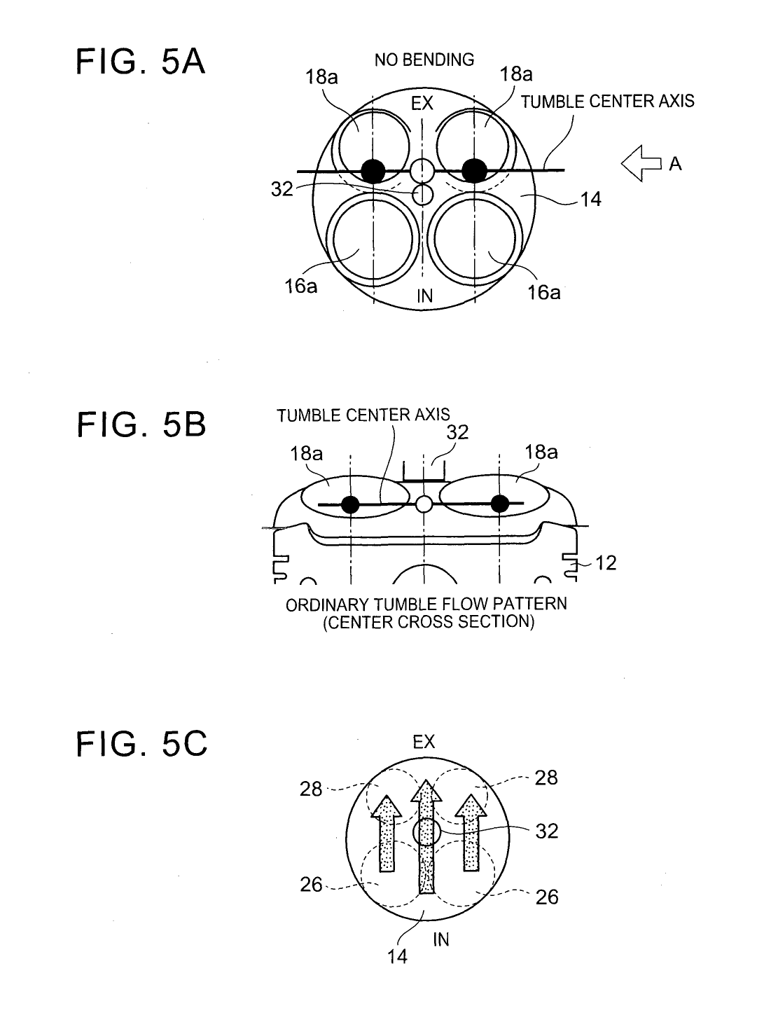

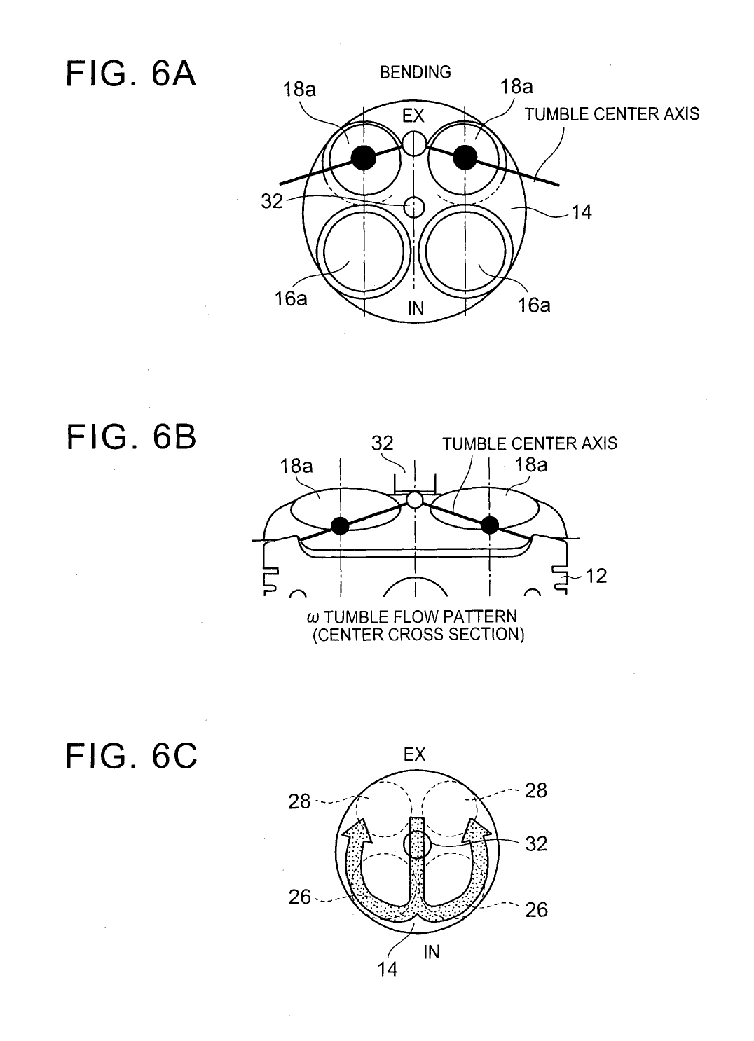

FIG. 5A to FIG. 5C are views for illustrating the characteristic of an ordinary tumble flow pattern. FIG. 6A to FIG. 6C are views for illustrating the characteristic of an ω tumble flow pattern. More specifically, FIG. 5A and FIG. 6A are plan views when the combustion chamber 14 is viewed from the upper side. FIG. 5B and FIG. 6B are side views when the combustion chamber 14 is viewed from the intake side. FIG. 5C and FIG. 6C are views when the combustion chamber 14 is viewed from the upper side, and respectively showing the flow direction of a tumble flow having an ordinary tumble flow pattern and the flow direction of a tumble flow having an ω tumble flow pattern. FIG. 5A to FIG. 5C and FIG. 6A to FIG. 6C show states at the timing near compression top dead center in a compression stroke.

The basic rotational direction of a tumble flow that is generated in each cylinder is a clockwise direction in FIG. 1, that is, a direction in which gas flowing from the intake ports 16a into the corresponding cylinder flows toward a top face of the combustion chamber 14, an in-cylinder wall surface adjacent to the exhaust valves 28, a top face of the piston 12, an in-cylinder wall surface adjacent to the intake valves 26 and the top face of the combustion chamber 14 in the stated order. A tumble center axis described below is obtained by connecting vortex center points of the tumble flow in cross sections of the combustion chamber 14 when viewed in the arrow A direction in FIG. 5A. The white circle in each of FIG. 5A and FIG. 5B and FIG. 6A and FIG. 6B indicates the vortex center point of the tumble flow in cross section taken at a cylinder bore center at which the ignition plug 32 is provided (in cross section taken in an intake/exhaust direction). The black circles in each of the drawings each indicate the vortex center point of the tumble flow in cross section taken along the axial centers of the pair of intake valve 26 and exhaust valve 28.

The tumble center axis of the ordinary tumble flow pattern is a horizontal non-curved axis with respect to the cylinder as shown in FIG. 5A and FIG. 5B. Therefore, the flow in the ordinary tumble flow pattern is an uniform flow from the intake side toward the exhaust side even in the second half of the compression stroke as shown in FIG. 5C. In contrast, the tumble center axis of the ω tumble flow pattern is a bent axis with a bending point set at the vortex center of the tumble flow at the cylinder bore center (ignition plug position) as shown in FIG. 6A and FIG. 6B. More specifically, in the ω tumble flow pattern, the vortex center position (indicated by the white circle) of the tumble flow in cross section taken at the cylinder bore center is higher than the vortex center positions therearound as shown in FIG. 6B. More specifically, near the compression top dead center, the tumble flow is biased upward with respect to a horizontal plane passing through the volume center of the combustion chamber 14 at the vortex center position of the tumble flow in cross section taken at the cylinder bore center. Hereinafter, a bias in such a mode is simply referred to as “bias of the vortex center of the tumble flow”. Therefore, in such a case, in a process in which in-cylinder gas is compressed in a compression stroke, a tumble flow that should be originally a single rigid vortex in the cylinder transforms into a tumble flow having two center axes because of bending of the tumble center axis (a tumble flow having two swirl flow (horizontal vortex flow) components having mutually opposite rotational directions when the combustion chamber 14 is viewed from the upper side). As a result, as shown in FIG. 6C, in the ω tumble flow pattern, an co-pattern flow is formed near the compression top dead center when the combustion chamber 14 is viewed from the upper side. As a result of generation of such an w-pattern flow, the flow direction of gas around the ignition plug 32 reverses near the compression top dead center in the compression stroke.

Additionally, in an intake stroke, the tumble center axis bends both in the ordinary tumble flow pattern and in the ω tumble flow pattern. In the case where the bending of the tumble center axis remains until near the compression top dead center, the ω tumble flow pattern is obtained. In the case where the bending of the tumble center axis disappears during the compression stroke, the ordinary tumble flow pattern is obtained.

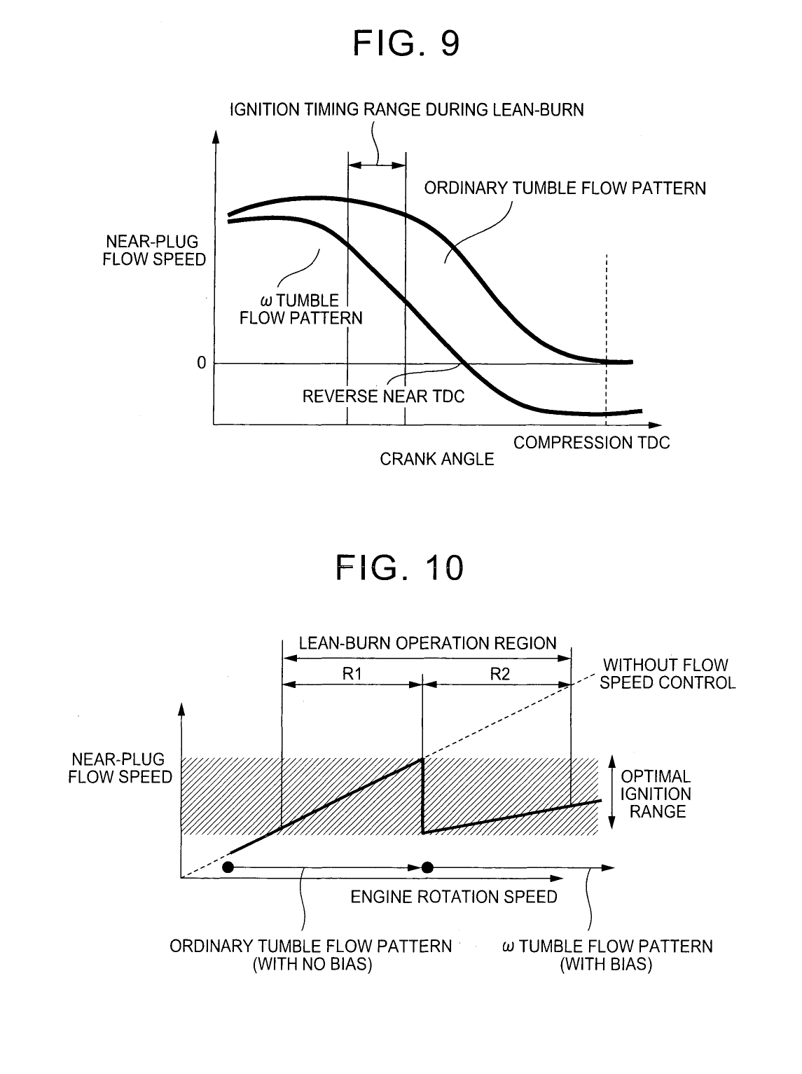

FIG. 7 is a view that shows a change in the gas flow speed in the cylinder in the second half of a compression stroke at the time when the tumble flow having the ω tumble flow pattern is generated. More specifically, the graph (A) shows a change in the gas flow speed at a measurement point A (plug gap position), the graph (B) shows a change in the gas flow speed at a predetermined position on a radially outer side of the cylinder bore with respect to the measurement point A, and the graph (C) shows a change in the gas flow speed at a predetermined position on a further radially outer side of the cylinder bore with respect to the measurement point A. In FIG. 7, the flow speed of a flow from the intake valve side toward the exhaust valve side is indicated by a positive value. This also applies to FIG. 9 (described later).

As shown in the graph (A) in FIG. 7, when the tumble flow having the ω tumble flow pattern is generated, the flow direction of in-cylinder gas at the plug gap position reverses, that is, the flow direction changes near the compression top dead center from a flow directed from the intake valve side toward the exhaust valve side to a flow directed from the exhaust valve side toward the intake valve side. As can be understood from a comparison among the graphs in FIG. 7, the change in the flow direction of in-cylinder gas becomes smaller as the position distances from the plug gap position. In the case shown in FIG. 7, the flow direction does not reverse at a measurement point C.

As described above, when the tumble center axis bends in the second half of the compression stroke and there occurs a bias in the vortex center of the tumble flow, the ω tumble flow pattern is obtained, so the flow direction of in-cylinder gas reverses at the cylinder bore center position (plug gap position) near the compression top dead center. Thus, the ordinary tumble flow pattern (first tumble flow pattern) is configured such that the gas flow speed around the ignition plug 32, which has been originally a flow directed from the intake valve side toward the exhaust valve side (as shown in FIG. 9 (described later)), converges to zero as approaching the compression top dead center. On the other hand, the ω tumble flow pattern (second tumble flow pattern) is configured such that the flow direction of gas around the ignition plug 32 reverses from the direction directed from the intake valve side toward the exhaust valve side to the direction directed from the exhaust valve side toward the intake valve side with a reduction in the near-plug flow speed in the second half of the compression stroke.

FIG. 8A and FIG. 8B are views for illustrating a condition suitable for generating a tumble flow having an ω tumble flow pattern. FIG. 8A shows a state of gas flow in the cylinder in the intermediate stage of the intake stroke. The speed of the piston 12 is maximum in the intermediate stage of the intake stroke. Generally, each intake valve 26 is set such that the valve lift becomes maximum at this timing. Therefore, as indicated by the arrow in FIG. 8A, intake air mass M at a large flow rate flows into the cylinder in the intermediate stage of the intake stroke, and is present near the intake valves 26.

FIG. 8B shows a state of gas flow in the cylinder at the time of the intermediate stage in the compression stroke, that is, at the time when the piston 12 has made one stroke from the timing shown in FIG. 8A. The tumble center point shown in FIG. 8B indicates the vortex center of a flow (state where there occurs a bias with respect to the volume center of the combustion chamber 14) mainly formed of the intake air mass M.

In the case shown in FIG. 8A and FIG. 8B, as shown in FIG. 8B, the intake air mass M shown in FIG. 8A turns about 270° in the cylinder while the piston 12 makes one stroke, and is then located at the intake side. In this case, because the intake air mass M is originally present, the bias of the vortex center of the tumble flow with respect to the volume center of the combustion chamber 14 in the second half of the compression stroke is accelerated. On that basis, in this case, because the intake air mass M is located at the intake side in the intermediate stage of the compression stroke at which the speed of the piston 12 is maximum, the flow of the mass M is further accelerated by the upward movement of the piston 12. As a result, the bias of the vortex center of the tumble flow in the compression stroke thereafter is facilitated.

On the contrary to the above-described case, when intake air mass is located at the exhaust side in the intermediate stage of the compression stroke, the upward movement of the piston 12 functions to cancel the speed of flow of the mass, while non-massive flow located at the intake side at this timing is slightly accelerated by the upward movement of the piston 12. As a result, on the contrary to the case shown in FIG. 8A and FIG. 8B, the vortex center of the tumble flow approaches the volume center of the combustion chamber 14, and the bending of the tumble center axis is eliminated.

From the above description, it is understood that, under the condition that intake air mass M at a large flow rate is located at the intake side at the timing at which the speed of the piston 12 is maximum in the compression stroke (in the intermediate stage of the compression stroke), the bias of the vortex center of the tumble flow effectively increases, and the tumble flow having the ω tumble flow pattern is effectively generated. That is, the tumble ratio range suitable for generating a tumble flow having an ω tumble flow pattern is a predetermined tumble ratio range of which the center tumble ratio is a tumble ratio at the time when in-cylinder gas turns during one stroke as in the case of the example shown in FIG. 8A and FIG. 8B. Conversely, when control that basically utilizes a tumble flow having an ordinary tumble flow pattern is executed, a target tumble ratio is desirably set so as to fall outside the tumble ratio range. The following control according to the present embodiment basically utilizes a tumble flow having an ordinary tumble flow pattern, so a tumble ratio outside the above tumble ratio range is used as a tumble ratio that is controlled by each TCV 24.

### Characteristic Portion of Control According to First Embodiment

FIG. 9 is a graph for illustrating a change in the near-plug flow speed in the second half of the compression stroke by comparison between the ordinary tumble flow pattern and the ω tumble flow pattern. As shown in FIG. 9, when the tumble flow having the ω tumble flow pattern is generated, the near-plug flow speed significantly decreases with the progress of generation of the co-pattern flow in the second half of the compression stroke as compared to the case where the tumble flow having the ordinary tumble flow pattern is generated, and finally the flow direction of gas around the ignition plug 32 reverses. As a result, the near-plug flow speed around the ignition timing decreases as compared to the case of the ordinary tumble flow pattern. Such a decrease in the near-plug flow speed becomes remarkable as the flow having the ω tumble flow pattern strengthens (the bias of the vortex center of the tumble flow strengthens). Thus, by controlling the tumble flow so that the pattern of the tumble flow is changed between the ordinary tumble flow pattern and the ω tumble flow pattern, it is possible to control the near-plug flow speed during ignition.

FIG. 10 is a graph for illustrating characteristic control over the near-plug flow speed during ignition according to the first embodiment of the invention. In the present embodiment, in order to control the near-plug flow speed during ignition within a predetermined flow speed range (optimal ignition range) in the lean-burn operation region, the pattern of the tumble flow is changed between the ordinary tumble flow pattern and the ω tumble flow pattern on the basis of the engine rotation speed. More specifically, as shown in FIG. 10, in a low engine rotation speed-side first engine rotation speed region R1 within the lean-burn operation region, the tumble flow is controlled so that generation of a flow having an ω tumble flow pattern is suppressed and a tumble flow having an ordinary tumble flow pattern is generated; whereas, in a high engine rotation speed-side second engine rotation speed region R2 within the lean-burn operation region, the tumble flow is controlled so that a tumble flow having an ω tumble flow pattern is generated.

The lean-burn operation region that is intended by control over the tumble flow according to the present embodiment may be a region set in advance so that lean-burn operation is carried out or may be a region that the position of the region in all the operation region or a range occupied by the region is changed as needed during operation. The lean-burn operation region may be all the operation region in which lean-burn operation is carried out in the internal combustion engine 10 or may be part of the region, in which ensuring ignitability is the most strict as a result of the fact that the internal combustion engine 10 is operated at the highest air-fuel ratio (or air-fuel ratio range) or the internal combustion engine 10 is operated by using the highest EGR rate (or EGR rate range).

The flow speed range shown in FIG. 10 is an optimal flow speed range (optimal ignition range) in which it is possible to avoid the inconvenience regarding the ignitability of air-fuel mixture during lean-burn operation, described above with reference to FIG. 3 to FIG. 4E. The optimal ignition range is obtained in consideration of variations in ignition among cycles. In the near-plug flow speed-engine rotation speed characteristic indicated by the dashed line, it is not possible to cause the entire near-plug flow speed during ignition in the lean-burn operation region to fall within the above-described flow speed range. In contrast, in the internal combustion engine 10 according to the present embodiment, it is possible to cause the near-plug flow speed during ignition to fall within the above-described flow speed range in the lean-burn operation region by controlling whether to generate a tumble flow having an ω tumble flow pattern on the basis of a change in the engine rotation speed.

### Control Over Tumble Flow Pattern by Changing Fuel Injection Timing of Each Port Fuel Injection Valve

The ECU 40 is able to change a fuel injection mode between an intake asynchronous injection mode and an intake synchronous injection mode by changing the fuel injection timing of each of the above-described port fuel injection valves 30. The intake asynchronous injection mode is configured such that fuel is injected during a period other than the valve open period of the corresponding intake valves 26 (more specifically, during an exhaust stroke in which the corresponding intake valves 26 are closed). The intake synchronous injection mode is configured such that fuel is injected during the valve open period of the corresponding intake valves 26.

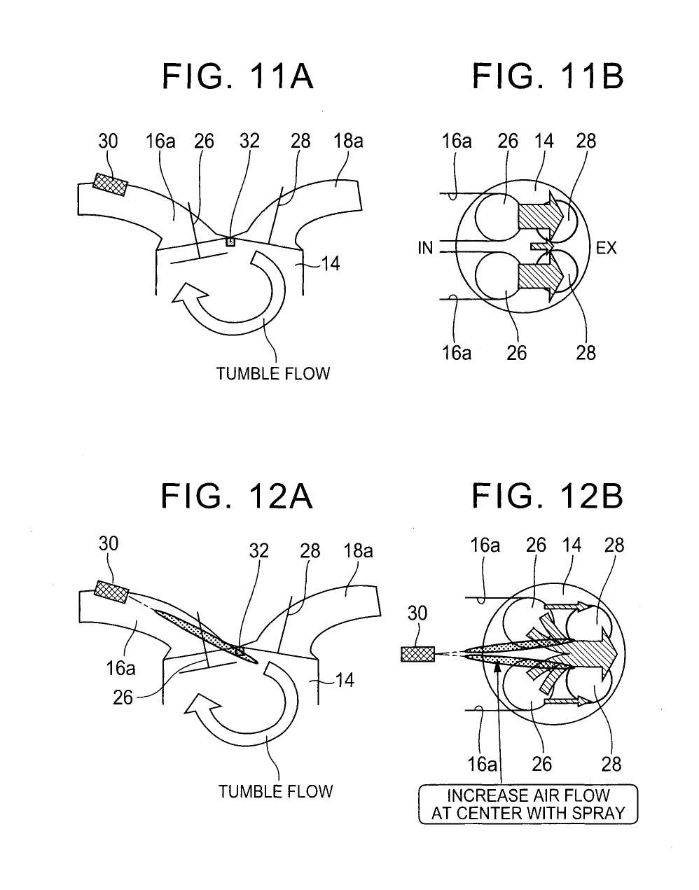

FIG. 11A and FIG. 11B are views for illustrating flow of gas flowing into each cylinder when fuel is injected in the intake asynchronous injection mode. FIG. 12A and FIG. 12B are views for illustrating flow of gas flowing into each cylinder when fuel is injected in the intake synchronous injection mode.

In the case where fuel is injected in the intake asynchronous injection mode, as indicated by the size of each of the arrows in FIG. 11B, within gas flowing from the intake ports 16a into the combustion chamber 14, components that are directed linearly from the centers of the two intake ports 16a toward the exhaust side are increased, so flow of the center (cylinder bore center) of the combustion chamber 14 relatively decreases.

In contrast, in the case where fuel is injected in the intake synchronous injection mode, it is possible to increase flow of gas flowing into the center of the combustion chamber 14 as shown in FIG. 12B by using fuel spray that directly flows in toward the center side of the combustion chamber 14 via the openings 26b as shown in FIG. 12A. More specifically, the flow speed of gas flowing into each cylinder at the center position of each intake port 16a (the position of the stem portion 26a of each intake valve 26) decreases, while the flow speed of gas flowing into each cylinder at the center of the corresponding combustion chamber 14 (the inner side of the corresponding combustion chamber 14 with respect to the stem portions 26a) is increased.

In control according to the present embodiment is based on the assumption that, when the intake asynchronous injection mode is utilized in the lean-burn operation region, the tumble ratio is controlled by the TCVs 24 so as to become a tumble ratio outside the tumble ratio range suitable for generation of a tumble flow having an ω tumble flow pattern. Thus, when the intake asynchronous injection mode is utilized, a tumble flow having an ordinary tumble flow pattern is generated. Instead of such control that uses the TCVs 24, control according to the present embodiment may be applied to an internal combustion engine of which the tumble ratio is set in advance by the shape, or the like, of each intake port 16a so that a tumble ratio outside the tumble ratio range is obtained.

On the other hand, when the flow speed of gas flowing into each cylinder is increased at the center of the corresponding combustion chamber 14 as shown in FIG. 12B by injecting fuel in the intake synchronous injection mode with the corresponding port fuel injection valve 30 having the configuration according to the present embodiment, it is possible to significantly bias the vortex center of the tumble flow. As a result, a tumble flow having an ω tumble flow pattern is allowed to be generated.

### Specific Example of Characteristic Control According to First Embodiment

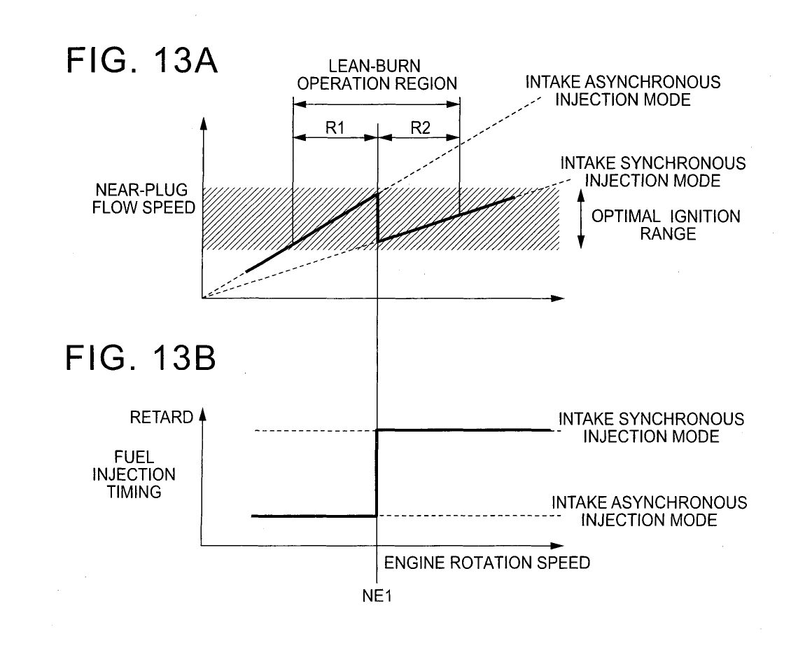

FIG. 13A and FIG. 13B are graphs for illustrating a method of controlling the near-plug flow speed during ignition by controlling whether to generate a tumble flow having an ω tumble flow pattern by changing the fuel injection timing of each port fuel injection valve 30 between the intake asynchronous injection mode and the intake synchronous injection mode.

In the method shown in FIG. 13A and FIG. 13B, the pattern of the tumble flow is controlled between the ordinary tumble flow pattern and the ω tumble flow pattern by controlling the fuel injection mode between the intake asynchronous injection mode and the intake synchronous injection mode with the port fuel injection valves 30 having the configuration according to the present embodiment. If the intake asynchronous injection mode is selected irrespective of the engine rotation speed, the near-plug flow speed falls outside the optimal ignition range in the high rotation speed-side region within the lean-burn operation region because of an increase in the gas flow speed, resulting from an increase in the engine rotation speed. Similarly, if the intake synchronous injection mode is selected, the near-plug flow speed falls outside the optimal ignition range in the low rotation speed-side region.

In the case shown in FIG. 13A and FIG. 13B, the intake asynchronous injection mode is used in the low rotation speed-side region (first engine rotation speed region R1) within the lean-burn operation region, with the result that it is possible to cause the near-plug flow speed to fall within the optimal ignition range by utilizing a tumble flow having an ordinary tumble flow pattern. In the present embodiment, in the engine rotation speed region R1 lower than a predetermined engine rotation speed NE1 at which the upper limit of the optimal ignition range is reached if the intake asynchronous injection mode remains selected, the intake asynchronous injection mode is selected.

On the other hand, in an engine rotation speed region (second engine rotation speed region R2) higher than or equal to the engine rotation speed NE1, the fuel injection timing is retarded with respect to that of the intake asynchronous injection mode, and the intake synchronous injection mode is selected. Thus, as shown in FIG. 13A, by generating a tumble flow having an ω tumble flow pattern, it is possible to reduce the near-plug flow speed near the engine rotation speed NE1 at which the tumble flow pattern is changed. In this way, by changing the tumble flow pattern on the basis of the engine rotation speed, it is possible to keep the near-plug flow speed during ignition within the optimal ignition range in the lean-burn operation region.

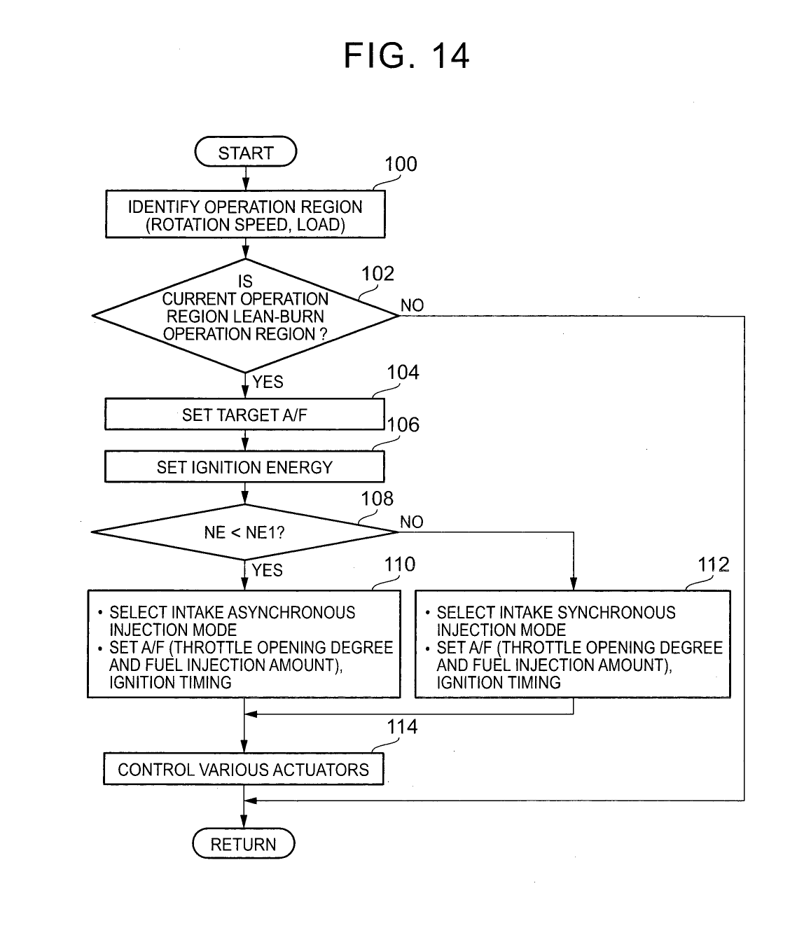

FIG. 14 is a flowchart that shows a control routine that is executed by the ECU 40 in order to implement characteristic control according to the first embodiment of the invention. The routine is repeatedly executed over each cylinder in each cycle of the internal combustion engine 10.

In the routine shown in FIG. 14, the ECU 40 initially determines (identifies) the current operation region (engine rotation speed and engine load) of the internal combustion engine 10 by utilizing the outputs of the air flow meter 20, crank angle sensor 42, and the like (step 100). Subsequently, the ECU 40 determines whether the current operation region is a lean-burn operation region in which the concentration of fuel in air-fuel mixture is low (step 102).

When it is determined in step 102 that the current operation region is the lean-burn operation region, the ECU 40 sets a target air-fuel ratio (A/F) (step 104). The ECU 40 stores a map (not shown) that defines a target air-fuel ratio on the basis of an operation region in terms of suppressing the amount of NOx emissions. The ECU 40 sets the target air-fuel ratio by consulting such a map in step 104.

Subsequently, the ECU 40 sets an ignition energy that is supplied to each ignition plug 32 on the basis of the set target air-fuel ratio (step 106). The ignition energy may be, for example, adjusted as follows. A plurality of ignition coils are provided for each ignition plug 32, and the number of ignition coils that are used for discharge is changed as needed.

Subsequently, the ECU 40 determines whether the current engine rotation speed NE is lower than the engine rotation speed NE1 (step 108). As described above, the engine rotation speed NE1 is a threshold at the time of changing the tumble flow pattern on the basis of the engine rotation speed in the lean-burn operation region. The engine rotation speed NE1 may be changed on the basis of the operating state of the internal combustion engine 10.

When affirmative determination is made in step 108 (NE<NE1), the ECU 40 selects the intake asynchronous injection mode, and sets respective target values of the throttle opening degree, fuel injection amount and ignition timing for achieving a required torque at the target air-fuel ratio in accordance with the predetermined map, or the like (step 110). On the other hand, when negative determination is made in step 108 (NE≧NE1), the ECU 40 selects the intake synchronous injection mode, and sets respective target values of the throttle opening degree, fuel injection amount and ignition timing for achieving a required torque at the target air-fuel ratio in accordance with a predetermined map, or the like (step 112). Subsequently, the ECU 40 controls the various actuators (the throttle valve 22, the port fuel injection valves 30 and the ignition plugs 32) in accordance with the selected fuel injection mode and the determined various target values (step 114).

With the above-described routine shown in FIG. 14, by changing the tumble flow pattern between the ordinary tumble flow pattern and the ω tumble flow pattern on the basis of the engine rotation speed by the use of a change in the fuel injection mode between the intake asynchronous injection mode and the intake synchronous injection mode with the port fuel injection valves 30 having the configuration shown in FIG. 2, it is possible to keep the near-plug flow speed during ignition within the optimal ignition range in the lean-burn operation region irrespective of whether the engine rotation speed is high or low. Particularly, even when the engine rotation speed has increased, it is possible to suppress an excessively high near-plug flow speed during ignition by generating a tumble flow having an ω tumble flow pattern. From above, it is possible to improve ignitability of air-fuel mixture during lean-burn operation.

With the method of controlling the tumble flow according to the present embodiment, it is possible to control whether to form a bias of the vortex center of the tumble flow (tumble pattern) without using control over the tumble ratio itself with the TCVs 24, and the like (that is, without reducing a turbulence of in-cylinder gas, which is important for combustion). Therefore, it is possible to improve ignitability of air-fuel mixture during lean-burn operation while expanding a lean limit (improving fuel economy).

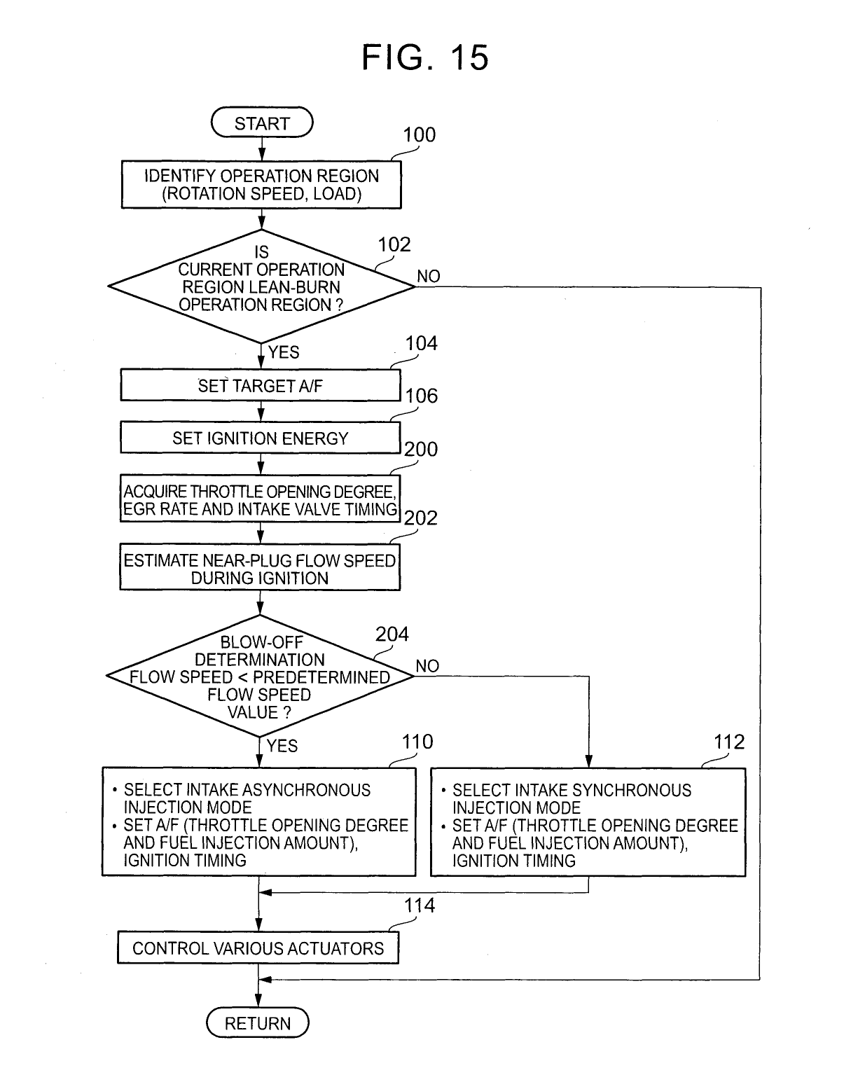

Incidentally, in the above-described first embodiment, the fuel injection mode is changed between the intake asynchronous injection mode and the intake synchronous injection mode on the basis of whether the engine rotation speed is lower than the predetermined engine rotation speed NE1, with the result that the pattern of the tumble flow is changed between the ordinary tumble flow pattern and the ω tumble flow pattern. However, a change of the pattern of the tumble flow between the first tumble flow pattern and the second tumble flow pattern through a change of the fuel injection mode in the invention may be performed on the basis of an estimated value of the near-plug flow speed as will be described below with reference to FIG. 15 instead of the engine rotation speed.

FIG. 15 is a flowchart that shows a control routine that is executed by the ECU 40 in order to implement characteristic control according to an alternative embodiment to the first embodiment of the invention. In FIG. 15, like step numbers denote the same steps as those of the steps shown in FIG. 14 in the first embodiment, and the description thereof is omitted or simplified.

In the routine shown in FIG. 15, after the ECU 40 sets the ignition energy in step 106, the ECU 40 acquires the throttle opening degree, the EGR rate and the intake valve timing (step 200). Subsequently, the ECU 40 calculates an estimated value of the near-plug flow speed during ignition (step 202). The estimated value of the near-plug flow speed during ignition is calculated on the basis of parameters that influence the near-plug flow speed, that is, the engine rotation speed, the throttle opening degree, the EGR rate and the intake valve timing (open/close timing), acquired in step 100 and step 202. The ECU 40 stores a map that defines in advance an estimated value of the near-plug flow speed during ignition in association with these parameters. The ECU 40 calculates the estimated value by consulting such a map. The map that is used in this case is set on the assumption of a situation that the intake asynchronous injection mode is used (that is, a situation that the ordinary tumble flow pattern is used). In an internal combustion engine in which not only the intake valve timing but also the exhaust valve timing is changed on the basis of the operating state, the near-plug flow speed during ignition may be estimated also in consideration of the influence of the exhaust valve timing.

Subsequently, the ECU 40 determines whether discharge spark during ignition is blown off on the basis of whether the estimated value of the near-plug flow speed, estimated in step 202, is lower than a predetermined flow speed value (step 204). The predetermined flow speed value in step 204 is set in advance as a threshold for determining whether there is a concern that blow-off (discharge interruption) of discharge spark occurs during ignition. The predetermined flow speed value may be, for example, changed on the basis of the air-fuel ratio that influences the ignitability of air-fuel mixture.

When it is determined in step 204 that the near-plug flow speed during ignition is lower than the predetermined flow speed value, that is, when it is determined that there is no concern of blow-off, the ECU 40 selects the intake asynchronous injection mode (step 110). On the other hand, when it is determined that the near-plug flow speed during ignition is higher than or equal to the predetermined flow speed value, that is, when it is determined that there is a concern of blow-off, the ECU 40 selects the intake synchronous injection mode (step 112).

With the above-described routine shown in FIG. 15, it is possible to suitably suppress an excessively high near-plug flow speed during ignition at a high engine rotation speed at which there is a concern of blow-off of discharge spark, and to prevent blow-off of discharge spark.

In the above-described first embodiment, the ordinary tumble flow pattern corresponds to a “first tumble flow pattern” according to the aspect of the invention, and the ω tumble flow pattern corresponds to a “second tumble flow pattern” according to the aspect of the invention. “Gas flow speed control means” according to the aspect of the invention is implemented by the ECU 40 executing the processes of step 108 to step 114. The intake asynchronous injection mode corresponds to a “first injection mode” according to the aspect of the invention. The intake synchronous injection mode corresponds to a “second injection mode” according to the aspect of the invention. “Fuel injection control means” according to the aspect of the invention is implemented by the ECU 40 executing the processes of step 108 to step 114.

### Second Embodiment

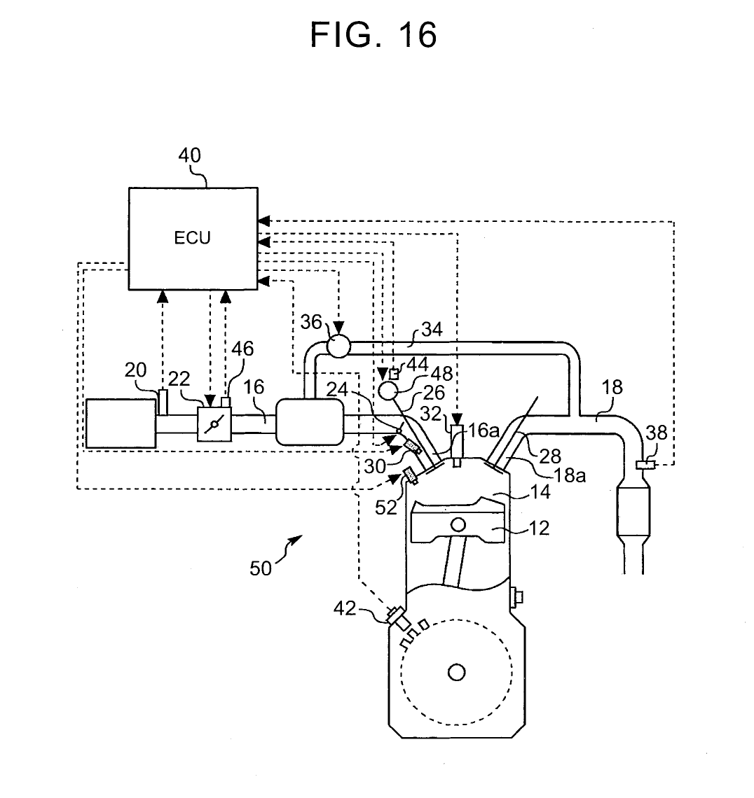

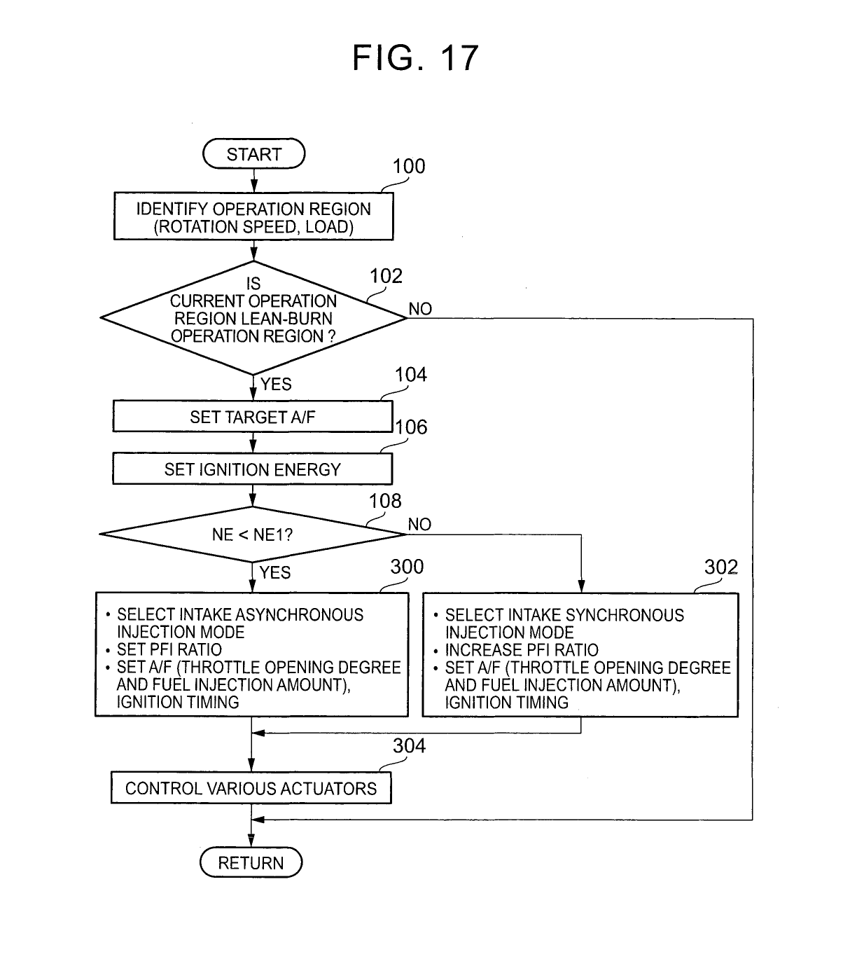

Next, a second embodiment of the invention will be described with reference to FIG. 16 and FIG. 17. A system according to the present embodiment is implemented by causing the ECU 40 to execute a routine shown in FIG. 17 (described later) instead of the routine shown in FIG. 14 by using the hardware configuration shown in FIG. 1.

### Description of System Configuration of Second Embodiment

FIG. 16 is a schematic view for illustrating the system configuration of an internal combustion engine 50 according to the second embodiment of the invention. In FIG. 16, like reference numerals denote the same elements as those shown in FIG. 1, and the description thereof is omitted or simplified.

As shown in FIG. 16, the internal combustion engine 50 according to the present embodiment differs from the above-described internal combustion engine 10 according to the first embodiment in that in-cylinder fuel injection valves 52 that directly inject fuel into the corresponding cylinders are provided in addition to the port fuel injection valves 30.

### Characteristic Portion of Control According to Second Embodiment

In the present embodiment, as well as the first embodiment, the pattern of the tumble flow is changed between the ordinary tumble flow pattern and the ω tumble flow pattern on the basis of the engine rotation speed by utilizing a change of the fuel injection mode between the intake asynchronous injection mode and the intake synchronous injection mode with the port fuel injection valves 30. Moreover, in the present embodiment, when the intake synchronous injection mode is selected, the ratio (hereinafter, referred to as “PFI ratio”) of the amount of fuel injected by the port fuel injection valves 30 to the total amount of fuel injected by the port fuel injection valves 30 and the in-cylinder fuel injection valves 52 is increased as compared to that when the intake asynchronous injection mode is selected.

### Specific Example of Characteristic Control According to Second Embodiment

FIG. 17 is a flowchart that shows a control routine that is executed by the ECU 40 in order to implement characteristic control according to the second embodiment of the invention. In FIG. 17, like step numbers denote the same steps as those of the steps shown in FIG. 14 in the first embodiment, and the description thereof is omitted or simplified.

In the routine shown in FIG. 17, when affirmative determination is made in step 108 (NE<NE1), the ECU 40 subsequently selects the intake asynchronous injection mode as the injection mode of each port fuel injection valve 30, sets the port fuel injection ratio (hereinafter, simply referred to as “PFI ratio”) on the basis of the operating state of the internal combustion engine 50, and sets respective target values of the throttle opening degree, fuel injection amount and ignition timing for achieving a required torque at the target air-fuel ratio in accordance with a predetermined map, or the like (step 300).

On the other hand, when negative determination is made in step 108 (NE≧NE1), the ECU 40 subsequently selects the intake synchronous injection mode as the injection mode of each port fuel injection valve 30 and increases the PFI ratio as compared to that when the intake asynchronous injection mode is selected (step 300), and sets respective target values of the throttle opening degree, fuel injection amount and ignition timing for achieving a required torque at the target air-fuel ratio in accordance with the predetermined map, or the like (step 302). After the process of step 300 or step 302 is executed, the ECU 40 controls the various actuators (the throttle valve 22, the port fuel injection valves 30, the ignition plugs 32 and the in-cylinder fuel injection valves 52) in accordance with the selected fuel injection mode and the determined various target values (including the PF1 ratio) (step 304).

With the above-described routine shown in FIG. 17, the internal combustion engine 50 that uses both the port fuel injection valves 30 and the in-cylinder fuel injection valves 52 is also able to suppress an excessively high near-plug flow speed during ignition by generating a tumble flow having an ω tumble flow pattern by the use of the intake synchronous injection mode with the port fuel injection valves 30 at a high engine rotation speed. By increasing the PF1 ratio when the intake synchronous injection mode is utilized, a tumble flow having an ω tumble flow pattern is further reliably generated.

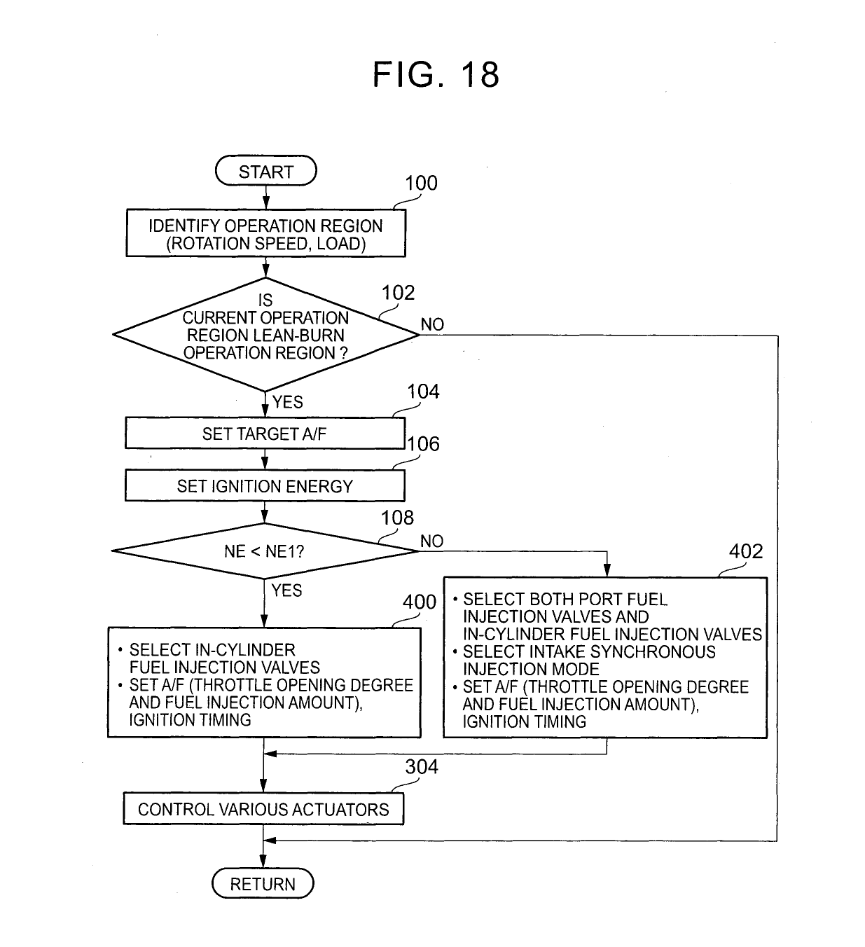

Incidentally, in the above-described second embodiment, description is made on an example in which fuel is injected in the intake asynchronous injection mode with the port fuel injection valves 30 when a tumble flow having an ordinary tumble flow pattern is generated. However, the first injection mode of the invention in the case where the port fuel injection valve and the in-cylinder fuel injection valve are provided is not limited to the configuration that fuel is injected in the intake asynchronous injection mode with the port fuel injection valve. That is, the first injection mode in this case also includes a mode in which fuel is injected by using the in-cylinder fuel injection valves 52 without using the port fuel injection valves 30. The second injection mode of the invention in the case where the port fuel injection valve and the in-cylinder fuel injection valve are provided assumes two modes. In one of the modes, fuel is injected by using both the port fuel injection valves 30 and the in-cylinder fuel injection valves 52 at a selected PFI ratio. In the other one of the modes, fuel is injected by using the port fuel injection valves 30 without using the in-cylinder fuel injection valves 52. A control routine in the case where such injection modes are employed will be described with reference to FIG. 18 (described later). Even when the in-cylinder fuel injection valves 52 are used without using the port fuel injection valves 30 as described above in the first injection mode, the PFI ratio in the case where the second injection mode is utilized is naturally higher than that in the case where the first injection mode is utilized.

FIG. 18 is a flowchart that shows a control routine that is executed by the ECU 40 in order to implement characteristic control according to an alternative embodiment to the second embodiment of the invention. In FIG. 18, like step numbers denote the same steps as those of the steps shown in FIG. 17 in the second embodiment, and the description thereof is omitted or simplified.

In the routine shown in FIG. 18, when affirmative determination is made in step 108 (NE<NE1), the ECU 40 subsequently selects the injection mode that uses only the in-cylinder fuel injection valves 52, and sets respective target values of the throttle opening degree, fuel injection amount and ignition timing for achieving a required torque at the target air-fuel ratio in accordance with the predetermined map, or the like (step 400).

On the other hand, when negative determination is made in step 108 (NE≧NE1), the ECU 40 subsequently uses both the port fuel injection valves 30 and the in-cylinder fuel injection valves 52 and selects the intake synchronous injection mode as the injection mode of the port fuel injection valves 30, and sets respective target values of the throttle opening degree, fuel injection amount and ignition timing for achieving a required torque at the target air-fuel ratio in accordance with the predetermined map, or the like (step 402). In step 402, only the port fuel injection valves 30 may be used.

In the second embodiment and the alternative embodiment to the second embodiment, as well as the above-described first embodiment, the fuel injection mode may be changed on the basis of determination as to whether the estimated value of the near-plug flow speed during ignition is higher than or equal to a predetermined flow speed value instead of determination as to whether the engine rotation speed is higher than or equal to the predetermined engine rotation speed NE1.

In the above-described second embodiment, “injection ratio adjusting means” according to the aspect of the invention is implemented by the ECU 40 executing the processes of step 108 and step 300 to step 304. In the above-described alternative embodiment to the second embodiment, the fuel injection mode in which fuel is injected by using the in-cylinder fuel injection valves 52 without using the port fuel injection valves 30 corresponds to a “first injection mode” according to the aspect of the invention. “Fuel injection control means” according to the aspect of the invention is implemented by the ECU 40 executing the processes of step 108, step 304 and step 400 to step 402.

### Third Embodiment

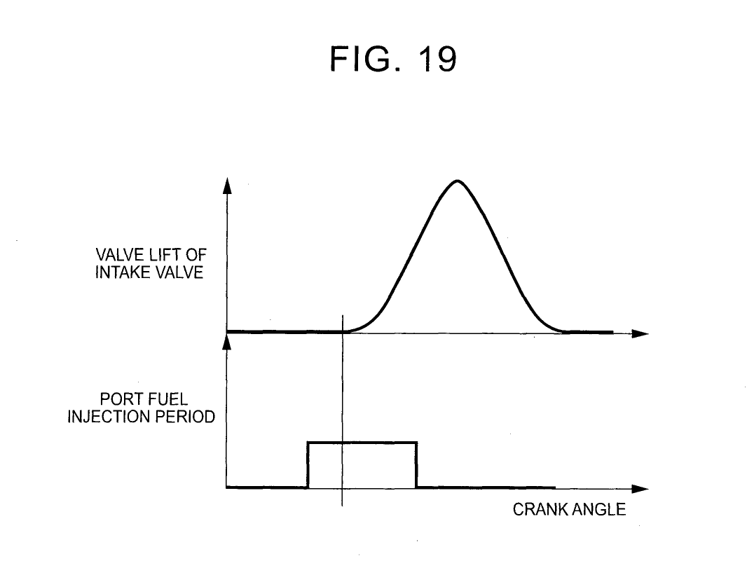

Next, a third embodiment of the invention will be described with reference to FIG. 19. The details of control according to the present embodiment described below are applicable in combination with any one of the above-described first and second embodiments.

### Characteristic Portion of Control According to Third Embodiment

FIG. 19 is a graph for illustrating a specific example of a method of utilizing the intake synchronous injection mode in which fuel is injected by using the port fuel injection valves 30 for generating a tumble flow having an ω tumble flow pattern.

In the above-described first and second embodiments, control for utilizing the intake synchronous injection mode with the port fuel injection valves 30 for generating a tumble flow having an ω tumble flow pattern is described. A method of utilizing the intake synchronous injection mode in this case may be, more specifically, a method in which the entire fuel injection amount assigned to the port fuel injection valves 30 is injected by the use of the intake synchronous injection mode (the entire fuel injection period overlaps with the open period of the corresponding intake valves 26). On the other hand, in view of facilitating mixing of injected fuel with intake air, the intake asynchronous injection mode is more desirable than the intake synchronous injection mode.

In the present embodiment, when the tumble flow having an ω tumble flow pattern is generated, part of the fuel injection period of each port fuel injection valve 30 overlaps with the open period of the corresponding intake valves 26 as shown in FIG. 19. That is, with the method according to the present embodiment, as for fuel injected at the initial stage of the fuel injection period until the intake valves 26 open, mixing of the fuel with intake air is facilitated equivalently to the intake asynchronous injection mode. Moreover, for the remaining fuel injection period from when the intake valves 26 open, fuel is injected in the intake synchronous injection mode because the remaining fuel injection period overlaps with the open period of the intake valves 26. When fuel is allowed to be injected by dividing the fuel injection period into multiple times, the injection mode is not limited to a mode in which part of a continuous single fuel injection period overlaps with the open period of the corresponding intake valves as in the case of the present embodiment, independent fuel injection periods may be respectively assigned to the intake asynchronous injection mode and the intake synchronous injection mode.

With the above-described method of utilizing the intake synchronous injection mode according to the present embodiment, a tumble flow having an ω tumble flow pattern is generated by the use of the intake synchronous injection mode, while the ability of mixing injected fuel with intake air is ensured.

### Other Embodiments

In the above-described first to third embodiments, control for causing the near-plug flow speed during ignition in the lean-burn operation region to fall within the optimal ignition range by changing the pattern of tumble flow between the ordinary tumble flow pattern and the ω tumble flow pattern on the basis of the engine rotation speed is described. However, control over the tumble flow according to the invention may be configured to simply change the pattern of tumble flow between the ordinary tumble flow pattern and the ω tumble flow pattern on the basis of the engine rotation speed without the configuration that actively controls the near-plug flow speed into the optimal ignition range. More specifically, as already described in the embodiments, changing the pattern of tumble flow between the ordinary tumble flow pattern and the ω tumble flow pattern on the basis of the engine rotation speed within a certain engine rotation speed region provides the effect of suppressing a change in the near-plug flow speed during ignition within the engine rotation speed region as compared to the case where such a change of the tumble flow pattern is not carried out. Thus, purely with the configuration that changes the pattern of tumble flow between the ordinary tumble flow pattern and the ω tumble flow pattern on the basis of the engine rotation speed, it is possible to provide a control system for a spark-ignition internal combustion engine, which contributes to improvement in ignitability of air-fuel mixture in lean-burn operation that is carried out under the condition that the concentration of fuel of air-fuel mixture is low.

In the above-described first to third embodiments, description is made on an example in which characteristic control according to the invention is applied to lean-burn operation in which the near-plug flow speed during ignition easily influences ignitability. However, control according to the invention is not necessarily limited to application to lean-burn operation. For example, the control may be applied to an internal combustion engine that is operated at a stoichiometric air-fuel ratio.

In the above-described first to third embodiments, the configuration that fuel is injected toward the two intake ports 16a with the single port fuel injection valve 30 as shown in FIG. 2 is described as an example. However, the invention is applicable to the following configuration. In a configuration in which a port fuel injection valve is provided one by one for each intake port (for example, a configuration in which port fuel injection valves are respectively provided for the two intake ports provided in correspondence with one cylinder, the direction in which fuel is injected from each port fuel injection valve may be directed toward the center side of the corresponding combustion chamber with respect to the stem portion of the intake valve.

What is claimed is:

1. A control system for a spark-ignition internal combustion engine, the spark-ignition internal combustion engine including
an intake valve,
an exhaust valve,
an intake port,
an ignition plug arranged near a center of an upper wall surface of a combustion chamber, the ignition plug being configured to ignite air-fuel mixture, and
a port fuel injection valve arranged in the intake port, a direction in which the port fuel injection valve injects fuel being set such that an injected fuel is directed toward the center of the combustion chamber through an opening of the intake valve when fuel is injected during an open period of the intake valve,
the control system comprising:
an electronic control unit configured to:
i) control a flow speed of gas around the ignition plug during ignition by changing a tumble flow between a first tumble flow and a second tumble flow, the first tumble flow being a tumble flow that a flow direction of gas around the ignition plug during ignition is a direction directed from the intake valve toward the exhaust valve in a second half of a compression stroke, the second tumble flow being a tumble flow that the flow direction of gas reverses from the direction directed from the intake valve toward the exhaust valve to a direction directed from the exhaust valve toward the intake valve in the second half of the compression stroke as a result of a change into a tumble flow having two swirl flow components in process of compression of the gas in the compression stroke, the two swirl flow components having mutually opposite rotational directions when the combustion chamber is viewed from an upper side; and
ii) generate the second tumble flow by overlapping at least part of a fuel injection period of the port fuel injection valve with the open period of the intake valve.

2. The control system according to claim 1, wherein
the spark-ignition internal combustion engine includes an in-cylinder fuel injection valve configured to directly inject fuel into a cylinder of the spark-ignition internal combustion engine, and
the electronic control unit is configured to set a ratio of an amount of fuel injected by the port fuel injection valve to a total amount of fuel injected by the port fuel injection valve and the in-cylinder fuel injection valve such that the ratio when the second tumble flow is generated is higher than the ratio when the first tumble flow is generated.

3. The control system according to claim 1, wherein the electronic control unit is configured to generate the second tumble flow when an engine rotation speed is higher than or equal to a predetermined speed.

4. The control system according to claim 1, wherein the electronic control unit is configured to generate the second tumble flow when (i) the flow speed of gas around the ignition plug during ignition is higher than or equal to a predetermined value and (ii) the flow speed of gas around the ignition plug during ignition is estimated on an assumption that the first tumble flow is generated.

5. The control system according to claim 1, wherein the electronic control unit is configured to overlap part of the fuel injection period of the port fuel injection valve with the open period of the intake valve when the second tumble flow is generated.

6. A control system for a spark-ignition internal combustion engine configured to generate a tumble flow in a cylinder of the spark-ignition internal combustion engine, the spark-ignition internal combustion engine including
an intake valve,
an intake port,
an ignition plug arranged near a center of an upper wall surface of a combustion chamber, the ignition plug being configured to ignite air-fuel mixture, and
a port fuel injection valve arranged in the intake port, a direction in which the port fuel injection valve injects fuel being set such that an injected fuel is directed toward the center of the combustion chamber through an opening of the intake valve when fuel is injected during an open period of the intake valve,
the control system comprising:
an electronic control unit configured to change an injection mode of fuel by the port fuel injection valve between a first injection mode and a second injection mode, the first injection mode being an injection mode that fuel is injected during a closed period of the intake valve when an engine rotation speed is lower than a predetermined speed, the second injection mode being an injection mode that fuel is injected during a period including at least part of the open period of the intake valve when the engine rotation speed is higher than or equal to the predetermined speed.

7. The control system according to claim 6, wherein
the spark-ignition internal combustion engine includes an in-cylinder fuel injection valve configured to directly inject fuel into the cylinder of the spark-ignition internal combustion engine, and
the electronic control unit is configured to set a ratio of an amount of fuel injected by the port fuel injection valve to a total amount of fuel injected by the port fuel injection valve and the in-cylinder fuel injection valve such that the ratio when the second injection mode is selected is higher than the ratio when the first injection mode is selected.

8. The control system according to claim 6, wherein the electronic control unit is configured to overlap part of a fuel injection period of the port fuel injection valve with the open period of the intake valve when the second injection mode is selected.

9. A control system for a spark-ignition internal combustion engine configured to generate a tumble flow in a cylinder of the spark-ignition internal combustion engine, the spark-ignition internal combustion engine including
an intake valve,
an intake port,
an ignition plug arranged near a center of an upper wall surface of a combustion chamber, the ignition plug being configured to ignite air-fuel mixture,
a port fuel injection valve arranged in the intake port, a direction in which the port fuel injection valve injects fuel being set such that the injected fuel is directed toward the center of the combustion chamber through an opening of the intake valve when fuel is injected during an open period of the intake valve, and
an in-cylinder fuel injection valve configured to directly inject fuel into the cylinder of the spark-ignition internal combustion engine,
the control system comprising:
an electronic control unit configured to change an injection mode of fuel between a first injection mode and a second injection mode, the first injection mode being an injection mode that fuel is injected by using the in-cylinder fuel injection valve without using the port fuel injection valve when an engine rotation speed is lower than a predetermined speed, the second injection mode being an injection mode that fuel is injected by using at least the port fuel injection valve out of the port fuel injection valve and the in-cylinder fuel injection valve while at least part of a fuel injection period of the port fuel injection valve is overlapped with the open period of the intake valve when the engine rotation speed is higher than or equal to the predetermined speed.

10. The control system according to claim 9, wherein the electronic control unit is configured to overlap part of the fuel injection period of the port fuel injection valve with the open period of the intake valve when the second injection mode is selected.
